(19) United States
(12) Patent Application Publication
(10) Pub. No.: US 2023/0006249 A1
(43) Pub. Date: Jan. 5, 2023

(54) BIOMASS-BASED SOLID COMPOSITE ELECTROLYTES FOR BATTERIES

(71) Applicant: University of Louisville Research Foundation, Inc., Louisville, KY (US)

(72) Inventors: Noppadon Sathitsuksanoh, Louisville, KY (US); Md. Anwar Hossain, Louisville, KY (US)

(73) Assignee: University of Louisville Research Foundation, Inc., Louisville, KY (US)

(21) Appl. No.: 17/780,961

(22) PCT Filed: Nov. 27, 2020
(86) PCT No.: PCT/US20/62501

§ 371 Date: May 27, 2022

Related U.S. Application Data
(60) Provisional application No. 62/941,157, filed on Nov. 27, 2019.

(51) Int. Cl. H01M 10/0565; H01M 8/1048; H01M 8/1067; H01M 8/1072; H01M 4/86; H01M 4/62

(52) U.S. Cl. CPC H01M 10/0565; H01M 8/1048; H01M 8/1067; H01M 8/1072; H01M 4/8663; H01M 4/62; H01M 2300/0082; H01M 2008/1095

(57) ABSTRACT

Provided are composite electrolytes having a bio-based gel electrolyte in an ordered structure of a porous solid. In some embodiments, the gel electrolyte includes a glycolate gel, a glycerate gel, a bio-based compound-derived gel or a combination thereof. Also provided are electrochemical systems (electrodeposition), redox flow batteries, fuel cells, lithium-ion batteries and lithium-metal batteries including the composite electrolytes, and methods for producing gel electrolytes. In some embodiments, the methods including reacting a polyol, optionally ethylene glycol, propanediol, butanediol, pentanediol, diethylene glycol, glycerol, or any combination thereof, with a lithium metal and/or a lithium salt, optionally lithium hydroxide, a sodium salt, optionally sodium hydroxide (NaOH), NaTFSI, NaBF₄, or NaPF₆; an aluminum salt; a potassium salt, a magnesium salt; a calcium salt; a zinc salt; or any combination thereof.

### CROSS REFERENCE TO RELATED APPLICATION

This application claims the benefit of U.S. Provisional Patent Application Ser. No. 62/941,157, filed Nov. 27, 2019, the disclosure of which is incorporated herein by reference in its entirety.

### TECHNICAL FIELD

The presently disclosed subject matter relates generally to compositions and methods for producing solid composite electrolytes, such as for use in a battery, from biomass, more particularly from biomass-derived polyols.

### BACKGROUND

Modern life runs on batteries, from phones in our palms, watches on our wrists, and laptops on our desks. Particularly important are electric-powered vehicles because they curtail the number of gasoline-powered cars that emit CO₂ at the tailpipe and contribute to global warming. Putting more electric vehicles on the road, in combination with renewable electricity production, is a key step to a sustainable future because they release zero carbon emissions.

Greater adoption of electric-powered vehicles is necessary before they will significantly lead to reduced carbon emission. Battery performance and cost are critical factors in promoting the use of electric vehicles. Lithium batteries have considerable potential for electric vehicles because of their high energy and power density. The battery electrolyte determines energy density, stability, and safety. Organic carbonate electrolytes in conventional lithium-ion batteries pose safety concerns because of non-uniform lithium deposition (lithium dendrite). The formation of lithium dendrite causes reduced energy density and cycle performance and potential fire and explosion. Ideally, we want batteries that (1) have a high energy density (>350 kWh/kg) to power electric vehicles and (2) sustain the energy density for many cycles (>1,000 cycles), so we do not lose performance over time that necessitates frequent replacement.

However, the safety concerns of conventional batteries are the main driver in the development of safer and high energy density electrolytes. Batteries are currently used everywhere, on the ships in the ocean to power generators, on airplanes to power electronic devices, on the road to power cars, and on NASA's space station. We do not want a fire in the ocean, on the road, in the air, or in outer space. The ability to develop safe, high energy-density, and long-lasting electrolytes for lithium batteries will enable their commercialization and applications in electric vehicles, portable electronic devices, and power grid.

Described herein is the development of biomass-derived gel electrolytes from polyols. The polyol-based gel electrolytes are non-flammable and have high ionic conductivity. Also described is the development of the biomass-based solvents as electrolytes and encapsulation of the liquid/solid/gel electrolytes immobilize the anion mobility in the electrolytes, enhancing the ionic conductivity.

### SUMMARY

This Summary lists several embodiments of the presently disclosed subject matter, and in many cases lists variations and permutations of these embodiments of the presently disclosed subject matter. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

The presently disclosed subject matter relates in some embodiments to gel electrolytes. In some embodiments, the gel electrolytes comprise, consist essentially of, or consist of a glycolate gel, a glycerate gel, a methylsulfonylmethane gel, or any combination thereof; one or more metal salts, wherein the one or more metal salts are selected from the group consisting of alkali salts, alkaline-earth salts, and transition salts; one or more anions (such as LiTFSI, LiFSI, LiPF6, LiClO4, NaTFSI, NaFSI, and NaPF6); and a biomass-derived compound and/or a polyol. In some embodiments, the alkali salts are selected from the group consisting of salts of lithium, sodium, and potassium; and/or the alkaline-earth salts are selected from the group consisting of salts of magnesium, beryllium, and calcium; and/or the transition salt is an aluminum salt. In some embodiments, the concentration of the one or more salts in the gel electrolyte is at least about 10 mol percent. In some embodiments, the gel electrolyte is in the form of a homogeneous eutectic mixture.

The presently disclosed subject matter relates in some embodiments to solid electrolytes. In some embodiments, the solid electrolytes comprise, consist essentially of, or consist of one or more porous solid materials. In some embodiments, the one or more porous solid materials are selected from the group consisting of a metal-organic framework (MOF), a zeolite, a silica-alumina, a mesoporous silica, activated carbon, asphalt, coal, a biomass-derived porous material, and a plastic material. In some embodiments, the metal-organic framework (MOF) is selected from the group consisting of UiO-66(Zr, Ce, Hf) MOF, a MIL-101(Al, Cr, Fe) MOF, a MIL-125(Ti) MOF, and a MIL-53(Al, Fe) MOF; and/or the zeolite is selected from the group consisting of ZSM-5, HY, BETA, SAPO, and MOR; and/or the mesoporous silica is SBA-15; and/or the plastic material is selected from the group consisting of polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene.

The presently disclosed subject matter also relates in some embodiments to solid electrolytes for use in an electrode.

The presently disclosed subject matter also relates in some embodiments to solid electrolytes for use as hosts for electrode materials. In some embodiments, the electrode materials are selected from the group consisting of sulfur (S), selenium (Se), tellurium (Te), and silicon (Si), which in some embodiments is silicon dioxide (SiO₂), and combinations thereof. In some embodiments, the solid electrolytes of the presently disclosed subject matter are for use as a host for electrode materials, optionally S, Se, Te, Si, and/or SiO₂, present in electrochemical and energy storage devices. In some embodiments, the electrochemical and energy storage devices are selected from the group consisting of batteries, capacitors, and fuel cells.

The presently disclosed subject matter also relates in some embodiments to solid electrolytes for use as templates for forming carbon templated electrode material.

The presently disclosed subject matter also relates in some embodiments to separators for use in electrochemical cells, wherein at least one separator comprises a solid electrolyte as disclosed herein.

The presently disclosed subject matter relates in some embodiments to composite electrolytes comprising, consisting essentially of, or consisting of one or more gel electrolytes as disclosed herein and one or more solid electrolytes as disclosed herein.

The presently disclosed subject matter relates in some embodiments to composite electrolytes as disclosed herein for use in electrochemical systems. In some embodiments, the electrochemical systems are selected from the group consisting of a rechargeable battery, a supercapacitor, a flow battery, an electrochromic device, and a fuel cell, or comprise any combination thereof In some embodiments of the composite electrolytes of the presently disclosed subject matter, the gel electrolyte is produced from a plant biomass and the solid electrolyte comprises a plastic material, optionally a plastic material selected from the group consisting of polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene, a combination thereof, or a compound derived therefrom. In some embodiments, the compound derived therefrom is an organic acid, which in some embodiments is selected from the group consisting of on oxalic acid, malic acid, malonic acid, succinic acid, acetic acid, and formic acid. In some embodiments, the plant biomass is generated from an agricultural product, optionally an agricultural product selected from the group consisting of corn stover, rice straw, wheat straw, and soybean straw; a hardwood, optionally a hardwood selected from the group consisting of poplar and eucalyptus; a softwood, optionally a softwood selected from the group consisting of pine, spruce, and douglas fir.

In some embodiments, the gel electrolyte has an ionic conductivity of at least about 10⁻⁴ S/cm. In some embodiments, the gel electrolyte, the composite electrolyte, or both are nonflammable.

In some embodiments, the composite electrolyte has a thermal stability of greater than 100° C. In some embodiments, an electrochemical cell comprising a composite electrolyte of the presently disclosed subject matter can operate at a temperature of below 4° C.

In some embodiments, the gel electrolyte is encapsulated in a porous solid material, which in some embodiments is selected from the group consisting of a metal-organic framework (MOF), a zeolite, a silica-alumina, a biomass-derived porous material, or any combination thereof. In some embodiments, the porous solid material is present within the gel electrolyte.

In some embodiments, the presently disclosed subject matter relates to an electrochemical device comprising the composite electrolyte of the presently disclosed subject matter. In some embodiments, the electrochemical device is a lithium-ion battery, a lithium-metal battery, an electrochromic device, an electrodeposition system, a fuel cell, a redox flow battery, or any combination thereof.

The presently disclosed subject matter also relates in some embodiments to methods for producing gel electrolytes. In some embodiments, the presently disclosed methods comprise reacting a polyol or other biomass-derived compound with a metal selected from the group consisting of lithium, sodium, aluminum, potassium, magnesium, calcium, and zinc, a salt thereof, and water or any combination thereof. In some embodiments, the lithium salt is selected from the group consisting of lithium hydroxide, LiPF₆, LiTFSI, and LiBF₄; and/or the sodium salt is selected from the group consisting of sodium hydroxide (NaOH), NaTFSI, NaBF₄ and NaPF₆. In some embodiments, the reacting comprises reacting the polyol with a lithium salt, optionally lithium hydroxide, at 25-60° C. for at least 1 hour. In some embodiments, the lithium salt is present in the reaction in a concentration of about 0.1 to about 5.0 M. In some embodiments, the polyol is selected from the group consisting of ethylene glycol, propanediol, butanediol, pentanediol, diethylene glycol, glycerol, and combinations thereof. In some embodiments, the metal salts are present in the gel electrolyte between 5-95 mol %. In some embodiments, water produced in the reacting step is removed, optionally by freeze-drying the products of the reaction.

In some embodiments, the presently disclosed methods further comprise doping the gel electrolyte with a lithium salt, a sodium salt, a potassium salt, an aluminum salt, a zinc salt, a calcium salt, a magnesium salt, or any combination thereof.

In some embodiments, the presently disclosed methods further comprise adding the gel electrolyte with electrolyte additives and/or organic solvents, consisting of vinylene carbonate, lithium carbonate, fluoroethylene carbonate, imidazole, gamma-valerolactone, n-methylpyrrolidone, and n-methylacetamide.

In some embodiments of the presently disclosed methods, the reacting step comprises a reaction mixture of a lithium metal and/or a lithium salt, optionally lithium hydroxide, LiPF₆, LiTFSI, and/or LiBF₄; a sodium salt, optionally sodium hydroxide, NaTFSI, NaBF₄, and/or NaPF₆; an aluminum salt; a potassium salt; a magnesium salt; a calcium salt; a zinc salt; or any combination thereof, with at least two additional components selected from the group consisting of a deep eutectic solvent, choline chloride, levulinic acid, formic acid, lactic acid, glycerol, citric acid, sorbitol, xylitol, and ethylene glycol.

Thus, it is an object of the presently disclosed subject matter to provide gel electrolytes, solid electrolytes, and composite electrolytes, such as for use in a battery, from biomass, more particularly from biomass-derived polyols.

An object of the presently disclosed subject matter having been stated herein above, and which is achieved in whole or in part by the presently disclosed subject matter, other objects will become evident as the description proceeds when taken in connection with the accompanying Figures and EXAMPLES as best described herein below.

### BRIEF DESCRIPTION OF THE FIGURES

FIGS. 1A-1F. Glycerol reacted with Li metal (FIGS. 1A and 1B). The glycerate gel was stable in the presence of Li metal and viscous (FIGS. 1C and 1D). Ionic conductivity (σ) of glycerate gel as a function of Li salt concentration showed the optimal Li salt concentration that reached the ionic conductivity of 4.5×10⁻³ S/cm (FIG. 1E). Cyclic voltammetry (CV) of the gel showed its stability after 37 cycles, suggesting stable SEI formation (FIG. 1F).

FIGS. 2A and 2B. Propylene carbonate/dimethyl carbonate electrolyte (PC/DCM=7/3 (v/v)) was flammable (FIG. 2A). Glycerate gel was non-flammable and thermogravimetric profile (TGA) of the glycerate gel indicated its thermal stability up to 150° C. (FIG. 2B).

FIG. 3. Therogravimetric analysis (TGA) of selected biomass-based deep eutectic solvents (DESs). These DESs have ChCl as HBA and various HBAs, including LAA (levulinic acid), FMA (formic acid), LAC (lactic acid), GLY (glycerol), CTA (citric acid), SOR (sorbitol), XYL (xylitol), and EGL (ethylene glycol).

FIG. 4 is a series of Arrhenius plots of the ChCl/glycerol and ChCl/ethylene glycol DESs.

FIG. 5 is a series of Arrhenius plots of the ChCl/glycerol DESs at varying ChCl content.

FIG. 6 is a plot showing the relationship between viscosity of electrolytes and their respective ionic conductivity.

FIGS. 7A and 7B. The charge-discharge curve of LiFePO₄/IL@MOF/Li. The solid composite electrolyte was UiO-66 (Zr-MOF) loaded with 1M LiTFSI in [PYR₁₄] [TFSI] at a current of 3 mA/g (FIG. 7A). Capacity vs. cycle number of LiFePO₄ using the solid composite electrolyte at a current of 3 mA/g (FIG. 7B).

FIG. 8 is the galvanostatic cycling performance of the selected deep eutectic solvent and methods of the presently disclosed subject matter.

FIG. 9 are photographs of exemplary porous plant-based solid materials that can be employed in the compositions and methods of the presently disclosed subject matter.

FIG. 10 is a schematic illustration of an exemplary flexible MOF separator of the presently disclosed subject matter.

FIGS. 11A-11D. Li⁺ transference number of from a symmetric cell with MOF (FIG. 11A) and Celgard (FIG. 11B) separators in fresh electrolyte over 14 hours time. EIS profiles of the cells with MOF (FIG. 11C) and Celgard (FIG. 11D) separators.

FIG. 12. Open-circuit voltage (OCV) retention profiles over 12 h of relaxation.

FIGS. 13A-13E. Cyclic voltammetry of cells with MOF (FIG. 13A) and Celgard (FIG. 13B) separators at a scan rate of 0.1 mV/s at 1^{st}, 5^{th}, and 10^{th} cycle (FIG. 13A). Galvanostatic charge/discharge performance of cells with MOF (FIG. 13C) and Celgard (FIG. 13E) separators at a current density of 0.2 C and 0.1 C, respectively, at 30° C. (FIG. 13C). Discharged capacity and coulombic efficiency of the Li—Se cells at 0.2 C over 100 cycles (FIG. 13D).

FIG. 14. Cell performance with MOF separator at different C-rates.

FIGS. 15A-15C. Depictions of exemplary gel electrolytes (FIG. 15A), gel electrolytes in porous solids (FIG. 15B), and porous solids in gel electrolytes (FIG. 15C).

FIG. 16. Schematic illustration of exemplary carbon-coated porous solids.

FIG. 17. An exemplary process for fabricating a porous solid separator.

FIGS. 18A-18C. Exemplary process for fabricating a porous solid separator on a membrane. The porous solid (FIG. 18C) can be applied to both sides of a membrane (FIG. 18B) or just to one side of a membrane (FIG. 18A).

### DETAILED DESCRIPTION

### I. Definitions

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. Mention of techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims.

The term “about”, as used herein to refer to a measurable value such as an amount of weight, time, etc., is meant to encompass in some embodiments variations of ±20%, in to some embodiments ±10%, in some embodiments ±5%, in some embodiments ±1%, in some embodiments ±0.1%, in some embodiments ±0.5%, and in some embodiments ±0.01% from the specified amount, as such variations are appropriate to perform the disclosed methods.

As used herein, the term “and/or” when used in the context of a list of entities, refers to the entities being present singly or in any possible combination or subcombination. Thus, for example, the phrase “A, B, C, and/or D” includes A, B, C, and D individually, but also includes any and all combinations and subcombinations of A, B, C, and D.

The term “comprising”, which is synonymous with “including” “containing”, or “characterized by”, is inclusive or open-ended and does not exclude additional, unrecited elements and/or method steps. “Comprising” is a term of art that means that the named elements and/or steps are present, but that other elements and/or steps can be added and still fall within the scope of the relevant subject matter.

As used herein, the phrase “consisting of” excludes any element, step, or ingredient not specifically recited. For example, when the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of the related disclosure or claim to the specified materials and/or steps, plus those that do not materially affect the basic and novel characteristic(s) of the disclosed and/or claimed subject matter.

For example, a method of the presently disclosed subject matter can “consist essentially of” one or more enumerated steps as set forth herein, which means that the one or more enumerated steps produce most or substantially all of the intended result to be produced by the claimed method. It is noted, however, that additional steps can be encompassed within the scope of such a method, provided that the additional steps do not substantially contribute to the result for which the method is intended.

With respect to the terms “comprising”, “consisting essentially of”, and “consisting of”, where one of these three terms is used herein, the presently disclosed and claimed subject matter can include the use of either of the other two terms. Similarly, it is also understood that in some embodiments the methods of the presently disclosed subject matter comprise the steps that are disclosed herein, in some embodiments the methods of the presently disclosed subject matter consist essentially of the steps that are disclosed, and in some embodiments the methods of the presently disclosed subject matter consist of the steps that are disclosed herein.

In some embodiments, the presently disclosed subject matter relates to addressing the safety concerns of liquid electrolytes by creating non-flammable polyol-based gel electrolytes with high ionic conductivity and stable cycling performance.

### II. Exemplary Embodiments

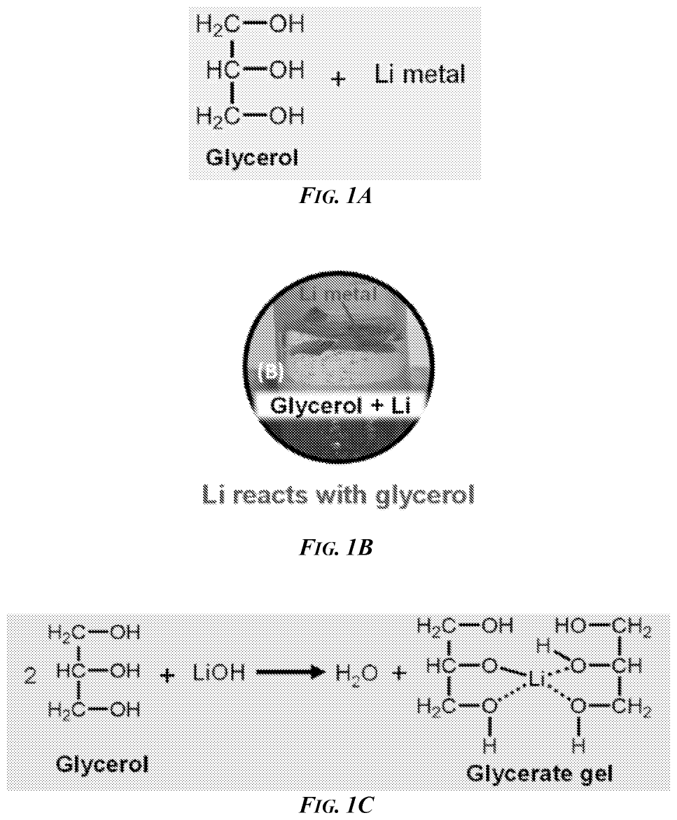

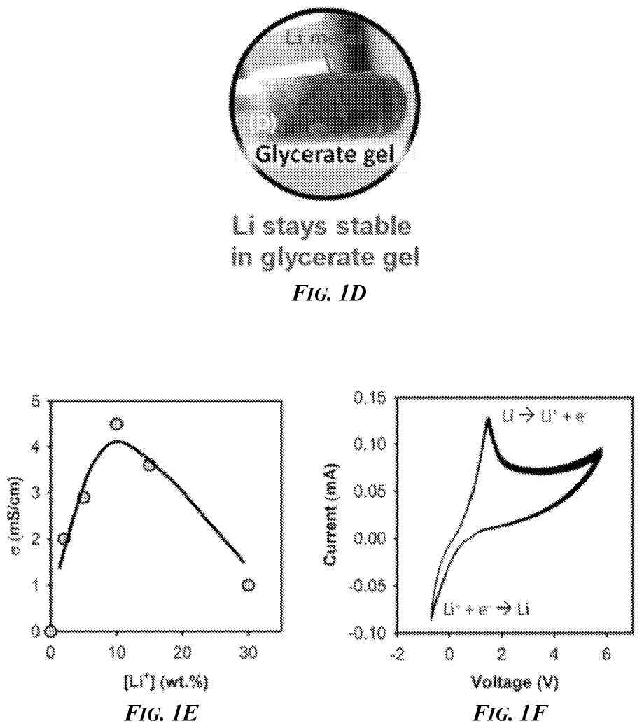

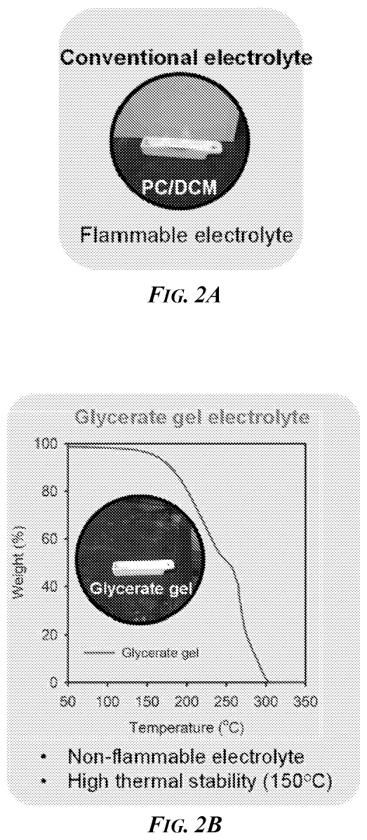

The dependence of ionic conductivity of liquid electrolytes on the Li salt concentration and viscosity form a foundation for the presently disclosed gel electrolyte systems. Typically, the viscosity of liquid electrolytes is inversely proportional to their ionic conductivities. Viscosity depends on the Li salt concentration and the nature of electrolytes themselves. In some embodiments, biomass-derived glycerate solvents can be prepared from glycerol. Typically, the —OH groups in glycerol make glycerol reactive with metals and cell components, resulting in capacity fade (FIGS. 1A and 1B). However, reacting these —OH groups with metal hydroxide (LiOH) at room temperature simply resulted in the formation of a stable viscous gel (FIGS. 1C).

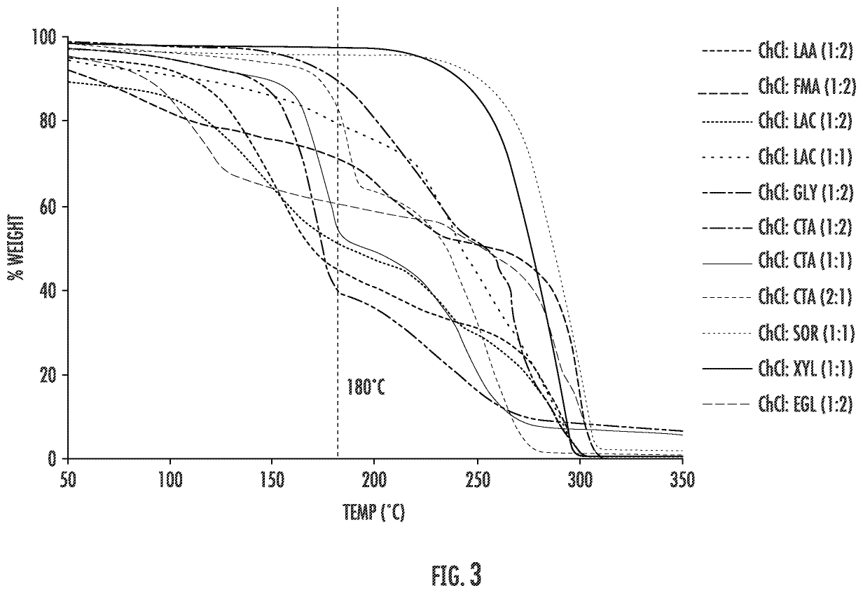

As preliminary work for the glycerate gel electrolyte, its ionic conductivity and chemical/stability with the cell components were investigated. The ionic conductivity of the gel was ˜4.5×10⁻³ S/cm (˜0.8M LiTFSI; FIG. 1E) and stable even after 37 cycles (FIG. 1F). The gel did not react with the Li-metal (FIG. 1D). Moreover, it was non-flammable and thermally stable (up to 150° C.; FIG. 2B), suggesting its potential use at an extreme environment. The gel had high thermal stability, non-flammability, and solubility of lithium salts. These attributes are important to overcome the limitations of conventional electrolytes for batteries. However, its physical and chemical characteristics, affecting their ionic conductivity and stable cycling performance are not well understood.

Thus, in some embodiments the presently disclosed subject matter relates to polyol-based gel electrolytes with high ionic conductivity (see Table 1). The polyols themselves have low ionic conductivities (<10⁻⁷ S/cm). By reacting these polyols with Li metal and/or LiOH and forming the gel electrolytes, the ionic conductivity of these gel electrolytes has been enhanced 1000-fold and reached 10⁻³ S/cm.

TABLE 1
Ionic Conductivity of Polyol and Polyol-derived Gel Electrolytes

Ionic conductivity (S/cm)

| Solvent | Polyol | Gel |
|---|---|---|
| Ethylene glycol | 3.77 × 10⁻⁷ | 2.25 × 10⁻³ |
| Propanediol | 2.00 × 10⁻⁷ | 2.79 × 10⁻⁴ |
| Butanediol | 1.87 × 10⁻⁷ | 3.65 × 10⁻⁴ |
| Pentanediol | 2.98 × 10⁻⁸ | 1.32 × 10⁻⁴ |
| Diethylene glycol | 8.68 × 10⁻⁷ | 1.22 × 10⁻⁴ |
| Glycerol | 2.00 × 10⁻⁸ | 2.33 × 10⁻⁴ |

As such, these results established the feasibility of synthesizing gel electrolytes by a simple method and demonstrated that they were not flammable and had high ionic conductivity at room temperature.

Gel electrolytes were synthesized by the hydrothermal reaction between glycerol (or polyols) and LiOH at 25-60° C. for 16 hours to ensure that the reaction was complete (see FIGS. 1A and 1B). Water was a by-product of this reaction and removed by freeze-drying, resulting in the gel. Lithium salt (˜1M) was doped into the gel by a simple dissolution, resulting in the glycerate gel electrolyte (see FIGS. 1C and 1D).

Electrochemical impedance spectroscopy (EIS) was conducted to determine the ionic conductivity (σ) of the electrolytes in the quartz cuvette to minimize the side reaction between the gel electrolyte and the cuvette materials (see FIG. 1E). Carbon-coated aluminum foil was used as electrodes. Cyclic voltammetry (CV) was conducted using the Li/gel/Pt cell at the scan rate of 0.1 mV/s (see FIG. 1F).

Flammability tests were performed by using a kitchen lighter (see FIG. 2A). A thermogravimetric profile (TGA) was conducted at a heating rate of 10/min in 50 cc/min N₂ (see FIG. 2B).

Besides flammability and explosion concerns, Li batteries suffer from non-uniform lithium deposition that causes reduced energy density and cycle performance. Solid electrolytes address the safety concerns, but they have low performance compared with conventional liquid electrolytes.

The presently disclosed subject matter thus relates in some embodiments to the area of energy storage devices, more specifically regarding batteries. In some embodiments, the presently disclosed subject matter relates to how to prevent fire/explosion in batteries by developing non-flammable electrolytes with high conductivity similar to the conventional liquid electrolytes; how to design the solid electrolytes for battery systems that enable uniform Li deposition, suppress Li dendrite (dead lithium) growth, and provide mechanical stability while maintaining the high ionic conductivity similar to the conventional liquid electrolytes; and 3) how to immobilize anions (from Li-salts) in the solid matrix, enhancing the cation (i.e., Li⁺) mobility.

Deep eutectic solvents (DESs) are a new class of solvents that exhibit unique physical and chemical properties. They form by using a combination of hydrogen bond acceptor (HBA) and hydrogen bond donor (HBD). Chloline chloride (ChCl)-based, methylsulfonylmethane (MSM)-based, and succinic anhydride (SCA)-based DESs were synthesized using various biomass-derived compounds, including ethylene glycol, glycerol, xylitol, and sorbitol. These DESs had a high thermal stability of >180° C. (FIG. 3) and high ionic conductivity (>10⁻³ S/cm; see Table 2).

TABLE 2
Chemical Properties and Ionic Conductivity of Selected DESs

| | | | | T_{decom} | σ (S/cm) |
|---|---|---|---|---|---|
| HBD | HBA | HBD:HBA* | Viscosity** | (° C.) | @ 25° C. |
| Ethylene | ChCl | 2:1 | 41.51 | 100 | 5.40 × 10⁻³ |
| glycol | | | | | |
| Glycerol | ChCl | 2:1 | 304.58 | 180 | 1.13 × 10⁻³ |
| Xylitol | ChCl | 1:1 | 8897.56 | 240 | 5.62 × 10⁻⁵ |
| Sorbitol | ChCl | 1:1 | 35565.54 | 250 | 1.90 × 10⁻⁵ |

*molar ratio;
**at 25° C. in mPa · s

Thermal Stability of Exemplary Biomass-based DESs. Thermal stability of the biomass-based DES was determined to be as follows: sorbitol>xylitol>glycerol>ethylene glycol. Moreover, it was determined that the ionic conductivity of these DESs increased as the viscosity increased. Since the ChCl: ethylene glycol DES yielded the highest ionic conductivity of 5.4×10⁻³ S/cm, the effect of ChCl on the ionic conductivity was further investigated. The changes in the mol % ChCl in DESs had little effect on the ionic conductivity (Table 3). Moreover, the addition of ChCl enhanced ionic conductivity of DESs (Table 4).

TABLE 3
The Effect of ChCl in the DESs on Ionic Conductivity

| | | HBD:HBA | |
|---|---|---|---|
| HBD | HBA | molar ratio | σ (S/cm) |
| Ethylene glycol | ChCl | 1:0 | 3.40 × 10⁻³ |
| Ethylene glycol | ChCl | 10:1 | 5.33 × 10⁻³ |
| Ethylene glycol | ChCl | 4:1 | 6.32 × 10⁻³ |
| Ethylene glycol | ChCl | 2:1 | 2.97 × 10⁻³ |

TABLE 4
The Effect of ChCl on Enhancement of Ionic Conductivity of DESs

Solvent properties

| | | HBD:HBA | 1M | σ (S/cm) |
|---|---|---|---|---|
| HBD | HBA | (molar ratio) | LiCl | @ 25° C. |
| Ethylene glycol | ChCl | 4:1 | ✓ | 4.58 × 10⁻³ |
| Ethylene glycol | LiCl | 4:1 | ✓ | 2.42 × 10⁻³ |
| Glycerol | ChCl | 4:1 | ✓ | 6.96 × 10⁻⁴ |
| Glycerol | LiCl | 4:1 | ✓ | 8.86 × 10⁻⁵ |

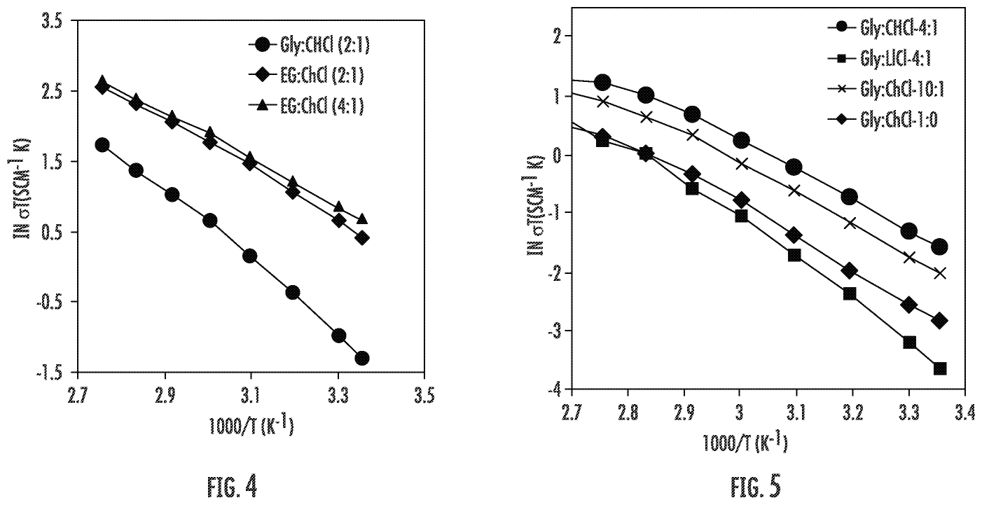

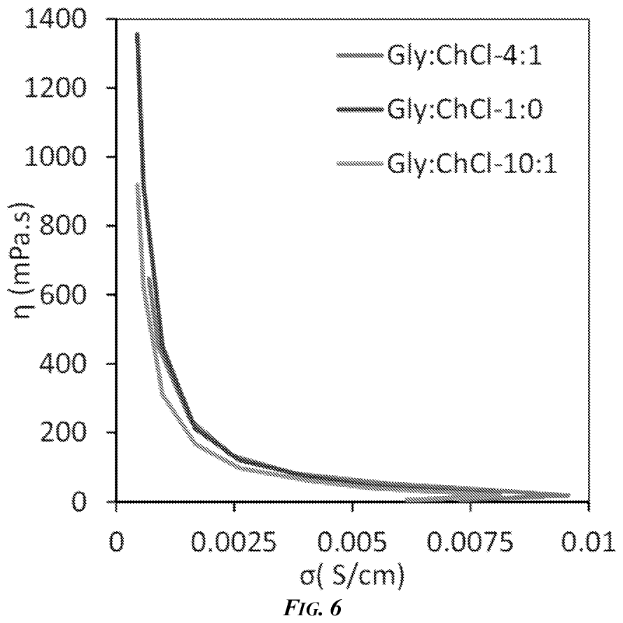

Arrhenius plots of the ChCl/glycerol and ChCl/ethylene glycol DESs revealed that ChCl/glycerol DES was more sensitive to the changes in temperature than ChCl/ethylene glycol (FIGS. 4-6). These results suggested that ChCl/ethylene glycol DESs could operate and maintain its ionic conductivity when the operating temperature fluctuated.

In some embodiments, the presently disclosed subject matter also relates to uses of solid composite electrolytes by incorporation of liquids, gels, and ionic liquids into porous materials. Solid electrolytes are promising solutions to suppress the lithium dendrite formation because the formation of lithium dendrite results in safety concerns from short-circuiting and fire/explosion.

Current solid electrolytes can be categorized into two classes of materials: (1) polymers (poly(acrylonitrile), poly(vinylidene fluoride), and poly(methyl methacrylate); and (2) inorganic ceramics (perovskite-type, sodium superconductor (NASICON)-type, garnet-type, and sulfide-type materials. Although solid electrolytes suppress Li dendrite formation, two important challenges remain: (1) low ionic conductivity and (2) instability of the solid-solid electrolyte interface (SEI). As set forth herein, the presently disclosed subject matter overcomes the safety concerns of liquid electrolytes by creating a non-flammable polyol-based gel electrolyte with high ionic conductivity and stable cycling performance.

Selected porous solid materials, including zeolites, metal-organic frameworks (MOFs), and metal oxides, contain Lewis acid sites. Lewis acid sites of these solids (MOFs) immobilize the anions in the electrolytes, enhancing the homogenous Li-ion flux and suppressing the Li dendrite formation. The density of Lewis acid sites can be increased by (1) adding a modulator during MOFs synthesis; and (2) increasing the number of atoms with high electronegativity in organic linkers. Increasing the concentration of modulators increases the density of Lewis acid sites.

The results presented herein demonstrated that acetic acid worked as a modulator during the synthesis of UiO-66 (Zr₆O₄(OH)₄(BDC)₆; Zr-MOFs). The added acetic acid competed with organic linkers during MOF synthesis, resulting in an increase in Lewis acid sites. It was determined that the UiO-66 with the 50 equivalents of acetic acid (to organic linker content) had 30% higher catalytic activity of the esterification of levulinic acid and methanol than the non-modulated UiO-66. These results suggested that adding modulators increased Lewis acid site density.

There are two main synthetic routes to gels incorporated in metal-organic frameworks: ionothermal and direct impregnation. Ionothermal synthesis works by directly synthesizing MOFs and gels simultaneously. However, this method requires that the MOF synthesis precursors are compatible with the polymers. This synthesis method has been employed to encapsulate ionic liquids in MOFs and found that the cationic and anionic components were separated by the MOF structure.

Compared with ionothermal syntheses, direct impregnation methods have the advantages of being simple and being post-synthetic incorporation methods. Wet impregnation and capillary action impregnation are both based on contacting the separately synthesized MOFs and ILs, either with a solvent or neat, whereas in-situ polymer synthesis involves producing the polymers from neutral components after they have been loaded into the MOF structure.

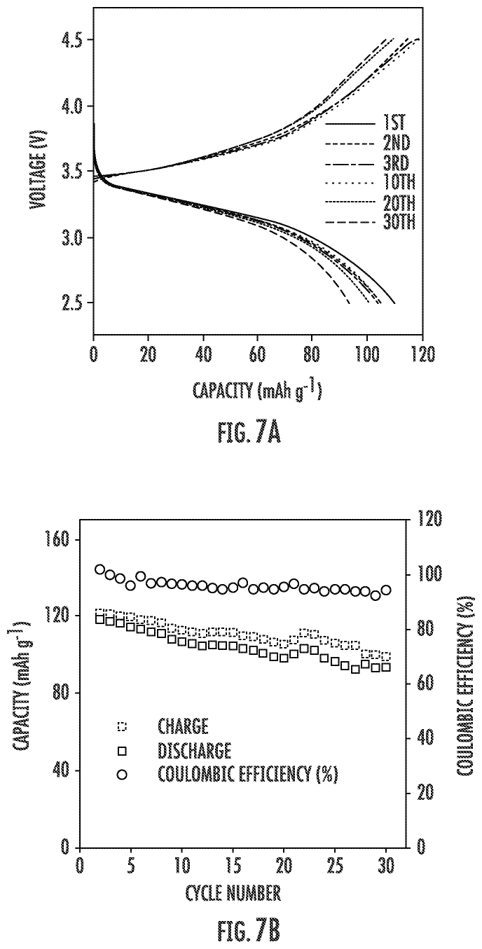

In previous studies, 1M LiTFSI was doped in the ionic liquid (IL), [PYR₁₄⁺][FSI⁻], forming the IL electrolyte. The IL electrolyte was then encapsulated in the UiO-66 MOFs (IL@MOFs) at the 100 wt. % IL electrolyte loading. The produced IL@MOFs were assembled into the CR2032 coin cell (LiFePO₄/IL@MOF/Li) and analyzed for the charge-discharge tests (FIG. 7).

The use of DESs enables an increase in Li salt loading. The cycling performance of the selected DES revealed a good cycling capability up to 50 cycles (FIG. 8).

The presently disclosed solid IL@MOFs composite electrolyte showed promising results with over 97% coulombic efficiency for this preliminary stage solid-state battery. The high Coulombic efficiency was achieved because the MOFs' channels trap the bulky TFSI anions in the porous structure, enhancing the mobility of Li ions. MOFs with a high Lewis acid site density enhance the salt dissociation and Li-ion transport. Moreover, the high density of Lewis acid sites of MOFs can immobilize the small and strong coordinating anions (e.g., Cl), providing uniform Li deposition and fast Li-ion transport. In sum, this presently disclosed subject matter established the feasibility of creating solid MOF electrolytes with a high density of Lewis acid sites.

The increasing demand for consumer electronics, electric vehicles (EVs), and power grids has spurred the development of rechargeable batteries. Lithium-ion batteries (LIBs) and Lithium-metal batteries (LMBs) have great potential in these markets. Current electrolytes in LIBs and LMBs are organic carbonates. The decomposition of these electrolytes, leading to severe capacity fading, Li dendrite formation, and fire hazards. Disclosed herein are plant biomass-based gel electrolytes (glycolate and glycerate gels) for LIBs and LMBs with a high ionic conductivity of >10⁻³ S/cm. These gels were non-volatile, stable, and rechargeable.

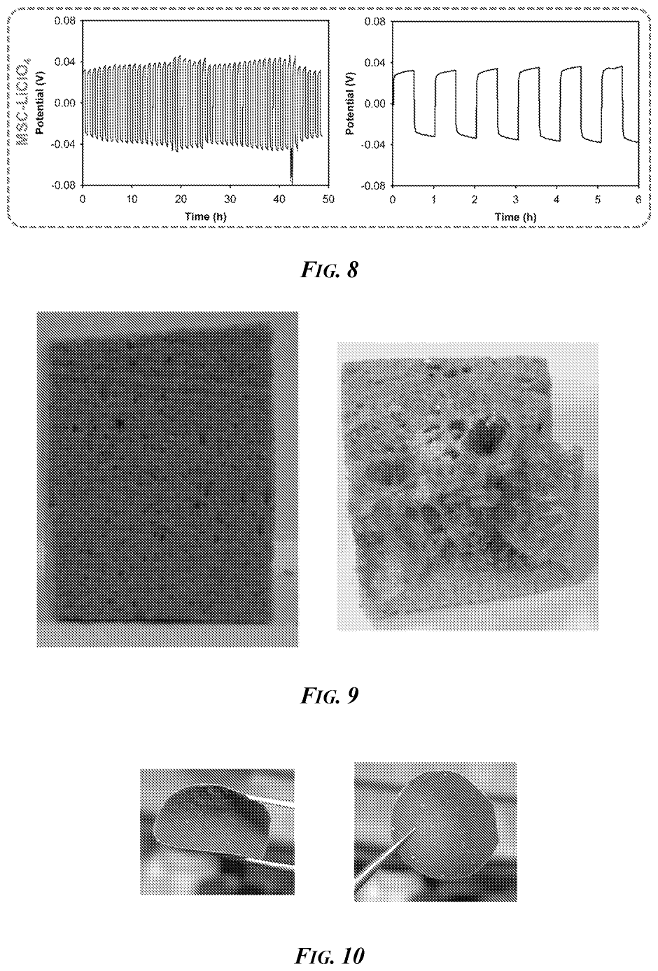

Solid electrolytes were produced by processing wood, sawdust, and wood chips, forming a solid electrolyte (FIG. 9). These solid electrolytes were non-flammable and fire-retardant, minimizing the fire hazards from the conventional electrolytes. They had low ionic conductivity of 10⁻⁶-10⁻⁴ S/cm.

These gels were also encapsulated in metal-organic frameworks (MOFs), zeolites, silica-alumina, and other porous solid materials, creating various types of gel-based solid composite electrolytes. The ionic conductivities of these gel-based solid composite electrolytes were >10⁻³ S/cm. In some embodiments, an MOF is made from plastic waste. In some embodiments, plastic wastes (including but not limited to wastes containing polyethylene terephthalate, polypropylene, polyethylene, and/or polystyrene) can be disintegrated into a monomeric soup or soups, which is/are thereafter used to synthesize porous solids

These results suggested that gel-based composite electrolytes combine the advantages of (1) high conductivity of gels; and (2) high mechanical stability and suppression of Li dendrite formation from porous solid materials, including plant biomass/wood (polymers) and ceramics.

Accordingly, the presently disclosed subject matter relates in some embodiments to gel electrolytes. In some embodiments, the gel electrolytes of the presently disclosed subject matter comprise, consist essentially of, or consist of a glycolate gel, a glycerate gel, a methylsulfonylmethane gel, or any combination thereof; one or more metal salts, wherein the one or more metal salts are selected from the group consisting of alkali salts, alkaline-earth salts, and transition salts; one or more anions, such as but not limited to LiTFSI, LiFSI, LiPF₆, LiClO₄, NaTFSI, NaFSI, and NaPF₆; and a biomass-derived compound and/or a polyol. Gel electrolytes and methods for producing the same are generally known, and include for example U.S. Pat. Nos. 6,667,106; 7,285,360; 7,517,615; 7,842,637; 8,828,609; 9,093,227; 9,853,287; and 10,573,933, the disclosure of each of which is incorporated herein in its entirety.

In some embodiments, the gel electrolytes of the presently disclosed subject matter comprise one or more metal salts. By way of example and not limitation, the metal salts that can be employed in the gel electrolytes of the presently disclosed subject matter include alkali salts such as, but not limited to salts of lithium, sodium, and potassium; and/or alkaline-earth salts such as, but not limited to of salts of magnesium, beryllium, and calcium; and/or the transition metal salts such as, but not limited to aluminum salts. In some embodiments, the concentration of the one or more salts in the gel electrolyte is at least about 10 mol percent.

In some embodiments, the materials of the gel electrolyte combine to form a homogeneous eutectic mixture. As would be understood by one of ordinary skill in the art, a homogenous eutectic mixture is a homogeneous mixture of constituents that melts or solidifies at a single temperature that is lower than the melting point of any of the constituents individually. Electrolytes comprising eutectic mixtures and general approaches to their production are disclosed, for example, in U.S. Pat. Nos. 7,630,117; 8,858,837; 8,802,301; 8,890,476; 9,059,477; 9,065,121; and 9,935,305, the disclosure of each of which is incorporated herein in its entirety.

In some embodiments, the presently disclosed subject matter relates to solid electrolytes, which in some embodiments can comprise, consist essentially of, or consist of one or more porous solid materials. Porous solid electrolytes and general approaches to their production are disclosed, for example, in U.S. Pat. Nos. 4,439,502; 8,309,925; 8,309,258; 9,368,775; and 10,622,666, the disclosure of each of which is incorporated herein in its entirety.

In some embodiments of the presently disclosed subject matter, the one or more porous solid materials employ a metal-organic framework (MOF), a zeolite, a silica-alumina, a mesoporous silica, activated carbon, asphalt, coal, a biomass-derived porous material, and a plastic material.

Metal-organic frameworks (MOFs) are porous and their pore structures can in some embodiments be connected. By changing the metal and/or linkers, pore structure can be tailored to enhance the transport of ions and/or compounds, and/or to suppress movement of metals, compounds, and/or ions. By way of example and not limitation, in some embodiments the metal-organic framework (MOF) is selected from the group consisting of a UiO-66(Zr, Ce, Hf) MOF (see e.g., U.S. Pat. No. 10,195,592, incorporated herein by reference in its entirety; see also Schoedel & Rajeh, 2020), an MIL-101(Al, Cr, Fe) MOF (see e.g., U.S. Pat. No. 9,777,029, incorporated herein by reference in its entirety), a MIL-125(Ti) MOF (see e.g., U.S. Pat. No. 10,347,939, incorporated herein by reference in its entirety), and a MIL-53(Al, Fe) MOF (see e.g., U.S. Pat. No. 9,163,036, incorporated herein by reference in its entirety). Exemplary zeolites and pore diameter characteristics thereof are summarized in Table 5.

TABLE 5
Structural Properties of Exemplary Zeolites

| | Channel System Pore Diameter |
|---|---|
| Zeolite | (nm × nm) |
| HY | 0.74 × 0.74 |
| BETA | 0.66 × 0.67 |
| ZSM-5 | 0.53 × 0.56 |
| SAPO-34 | 0.38 × 0.38 |
| MOR | 0.65 × 0.70 |

Alternatively or in addition, the one or more porous solid materials can employ a zeolite. Exemplary zeolites that can be employed in the porous solid materials of the presently disclosed subject matter include, but are not limited to a ZSM-5 zeolite (see e.g., U.S. Pat. No. 10,427,143, incorporated herein by reference in its entirety), an HY zerolite (see e.g., U.S. Pat. No. 8,932,974, incorporated herein by reference in its entirety), a BETA zeolite (see e.g., U.S. Pat. No. 9,688,541, incorporated herein by reference in its entirety), a silicoaluminophosphate (SAPO) zeolite (see e.g., U.S. Pat. No. 7,550,641, incorporated herein by reference in its entirety), and a mordenite (MOR) zeolite (see e.g., U.S. Pat. No. 6,692,640, incorporated herein by reference in its entirety), or any combination thereof. In some embodiments, the porous solid derived from a zeolite (e.g., ZSM-5) has unique pore channel structure and pore openings. These features can be tailored by chemical modification (including but not limited to washing with base and/or acid solutions such as but not limited to NaOH, HF, and/or HNO₃) or washing with chelating agents (such as but not limited to citric acid and/or acetic acid)) and/or by hydrothermal treatment (such as but not limited to heat and/or steam). In doing so, enhancement of the transport of ions and/or compounds and/or the suppression of metal, compound, and/or ion movement can be adjusted as desired.

Alternatively or in addition, the one or more porous solid materials can employ a mesoporous silica. Exemplary mesoporous silicas that can be employed in the porous solid materials of the presently disclosed subject matter include, but are not limited to an SBA-15 mesoporous silica.

Alternatively or in addition, the one or more porous solid materials can employ a plastic material. Exemplary plastic materials that can be employed in the porous solid materials of the presently disclosed subject matter include, but are not limited to polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene. In some embodiments, a plastic material is derived from a waste plastic such as but not limited to a waste plastic bottle.

In some embodiments, the solid electrolytes of the presently disclosed subject matter are designed for use in an electrode.

In some embodiments, the solid electrolytes of the presently disclosed subject matter are designed for use as a host for electrode materials, optionally S, Se, Te, Si, and/or SiO₂ in electrochemical and energy storage devices. In some embodiments, the electrochemical and energy storage devices are selected from the group consisting of batteries, capacitors, and fuel cells.

In some embodiments, the solid electrolytes of the presently disclosed subject matter are designed for use as a template for forming a carbon templated electrode material. While not wishing to be bound by any particular process for forming a carbon templated electrode material, in some embodiments the porous solid is soaked with one or more biomass-derived compounds (including but not limited to glucose, fructose, sucrose, and/or furfuryl alcohol), after which the soaked solids are subjected to heat at 100-150° C. to polymerize the biomass-derived compounds for 1-12 hours. Inert gases (such as but not limited to nitrogen, helium, and argon) are then passed through the resulting solids in the furnace/oven using heat between 600-900° C. and/or non-thermal plasma at an applied input voltage between 2.5-10 kV to form a carbon coating (FIG. 16). These coated porous solids can be used as electrodes (cathode and anode) in energy storage devices. In some embodiments, the generation of carbon using this approach provides electronic conductivity and ionic paths.

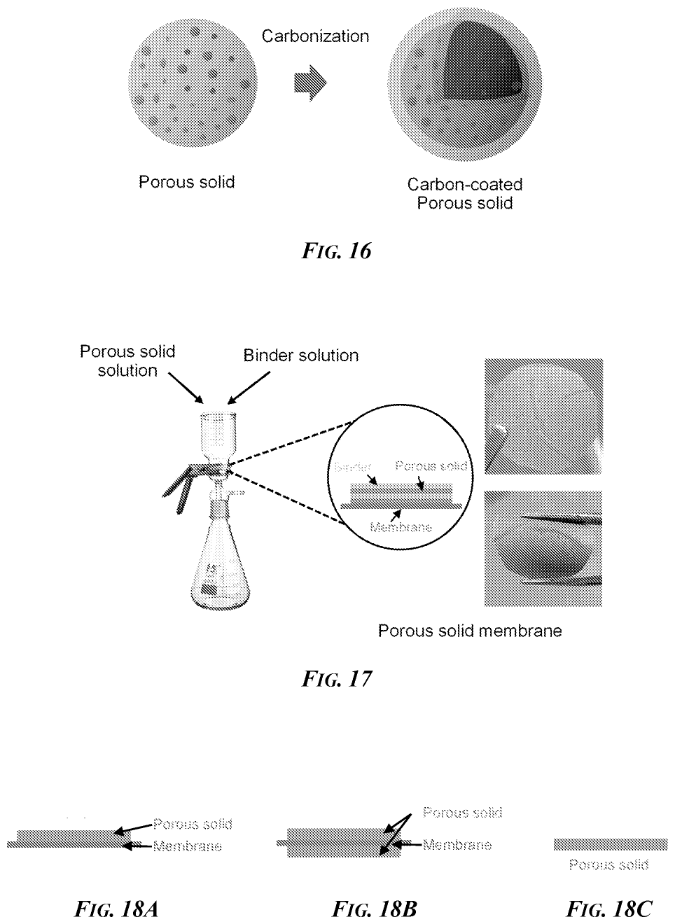

Additionally, in some embodiments the presently disclosed subject matter relates to separators for use in electrochemical cells. In some embodiments, a separator of the presently disclosed subject matter comprises a solid electrolyte as described herein. By way of example and not limitation, in some embodiments a solid electrolyte of the presently disclosed subject matter can be suspended in a solvent (including but not limited to water, one or more alcohols, and/or acetone) to make a solid concentration of 0.1-10 wt. %. The separator can thereafter be produced by filtering the solution of solid electrolytes on the surface of a membrane such as, but not limited to a polypropylene membrane, a filter paper, etc., followed by filtration of the 5-20 wt. % plasticizers/binder (poly(vinylidene fluoride-co-hexafluoropropylene; PVDF-HFP (in some embodiments, molecular weight 455000 Da)) in a solvents (e.g., water and/or acetone; see FIG. 17 for an exemplary depiction). The filtration step can be repeated (e.g., 3-5 times) to generate a layer of porous solid membrane with a desired thickness (FIG. 18A). The porous separator can be coated on both sides of the membrane (FIG. 18B) or peeled off from the membrane (FIG. 18C). These porous solid separators can thereafter be used in energy storage devices (batteries) to in some embodiments enhance their performance by immobilizing anions and intermediate reaction products (e.g., Li₂Se_{y}, Li₂S_{y}, 2≤y≤8) and/or block the side reactions of soluble redox intermediates (e.g., S-, Se-, Te-based compounds) and/or selectively allow transport of cations (e.g., Li, Na, Al, Mg, and K ions). Thus, in some embodiments a porous solid of the presently disclosed subject matter prevents the dissolution of the active electrode materials (e.g., S, Se, Te, Si, and SiO₂) in liquid electrolytes, modulates the formation and shuttling of the soluble redox intermediates (e.g., S-, Se-, Te-based compounds), and/or accommodates volume changes that can occur during lithiation and delithiation.

The presently disclosed subject matter also relates in some embodiments to composite electrolytes. Composite electrolytes of the presently disclosed subject matter comprise, consist essentially of, or consist of one or more gel electrolytes as described herein and one or more solid electrolytes as described herein.

The composite electrolytes of the presently disclosed subject matter can be employed for any purpose for which electrolytes are generally employed, although in some embodiments the composite electrolytes of the presently disclosed subject matter are for use in electrochemical systems. Exemplary electrochemical systems for which the composite electrolytes of the presently disclosed subject matter are appropriate include, but are not limited to rechargeable batteries, supercapacitors, flow batteries, electrochromic devices, and fuel cells.

In some embodiments, the gel electrolyte of the composite electrolyte is produced from a plant biomass and the solid electrolyte of the composite electrolyte comprises a plastic material. In some embodiments, the plastic material employed is selected from the group consisting of polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene, a combination thereof, or a compound derived therefrom. In some embodiments, the compound derived therefrom is optionally an organic acid selected from the group consisting of on oxalic acid, malic acid, malonic acid, succinic acid, acetic acid, and formic acid.

In some embodiments, the plant biomass employed for producing components of the electrolytes of the presently disclosed subject matter is generated from one or more agricultural products. Exemplary, non-limiting agricultural products from which plant biomass can be generated include corn stover, rice straw, wheat straw, and soybean straw; hardwoods including but not limited to poplar and eucalyptus, and/or softwoods including but not limited to pine, spruce, and douglas fir. Any of these agricultural products can be used individually or in any combination to generate plant biomass for use in the electrolytes of the presently disclosed subject matter.

The composite electrolytes of the presently disclosed subject matter comprise in some embodiments one or more gel electrolytes that are characterized by an ionic conductivity of at least about 10⁻⁴ S/cm.

In some embodiments, the gel electrolyte, the solid electrolyte, and/or the composite electrolyte is/are nonflammable.

The composite electrolyte of the presently disclosed subject matter can in some embodiments have a thermal stability of greater than 100° C. Alternatively or in addition, electrochemical cells that comprise one or more of the composite electrolytes of the presently disclosed subject matter can operate at lower temperatures including but not limited to temperatures of below 4° C.

The composite electrolytes of the presently disclosed subject matter can take various forms. By way of example and not limitation, in some embodiments the gel electrolyte (see FIG. 15A) is encapsulated in a porous solid material (see FIG. 15B). In some embodiments, the porous solid material is selected from the group consisting of a metal-organic framework (MOF), a zeolite, a silica-alumina, a biomass-derived porous material, or any combination thereof.

Alternatively, the porous solid material can present within the gel electrolyte (see FIG. 15C).

It is understood that the composite electrolytes of the presently disclosed subject matter can include combinations of one or more gel electrolytes encapsulated in one or more porous solid materials along with combinations of one or more porous solid materials present within one or more gel electrolytes. Stated another way, the arrangements of gel electrolytes and porous solid materials that can be employed in the composite electrolytes of the presently disclosed subject matter include all combinations and subcombinations of gel electrolytes encapsulated in one or more porous solid materials and/or porous solid materials present within one or more gel electrolytes.

The electrolytes of the presently disclosed subject matter, including the gel electrolytes, the solid electrolytes, and the composite electrolytes described herein, can be employed for any purpose for which electrolytes would be appropriate. In some embodiments, one or more gel electrolytes, solid electrolytes, and/or composite electrolytes described herein are employed in an electrochemical device. Exemplary, non-limiting electrochemical devices for which the gel electrolytes, the solid electrolytes, and/or the composite electrolytes described herein can be deployed include lithium-ion batteries, lithium-metal batteries, electrochromic devices, electrodeposition systems, fuel cells, redox flow batteries, and any combination thereof.

General methods for producing the electrolytes of the presently disclosed subject matter are known and are described in the U.S. Patents cited herein above. However, in some embodiments, the presently disclosed subject matter relates to methods for producing gel electrolyte by using an exchange in hydrogen bonds (reaction between hydrogen bond donors and hydrogen bond acceptors). Thus, in some embodiments the presently disclosed subject matter relates to methods for producing gel electrolytes that comprise, consist essentially of, or consist of reacting one or more polyols and/or other biomass-derived compounds with one or more metals to produce a gel electrolyte.

Various metals can be employed in the presently disclosed methods, including but not limited to lithium, sodium, aluminum, potassium, magnesium, calcium, and zinc, as well as salts thereof and any combination thereof. By way of example and not limitation, in some embodiments the presently disclosed methods employ a lithium salt, which in some embodiments is selected from the group consisting of lithium hydroxide, LiPF₆, LiTFSI, and LiBF₄. Alternatively or in addition, in some embodiments the presently disclosed methods employ a sodium salt, which in some embodiments is selected from the group consisting of sodium hydroxide (NaOH), NaTFSI, NaBF₄ and NaPF₆.

In some embodiments of the presently disclosed methods, the reacting step comprises reacting one or more polyols with a lithium salt, optionally lithium hydroxide, at 25-60° C. for at least 1 hour. In some embodiments, the lithium salt is present in the reaction in a concentration of about 0.1 to about 5.0 M.

In some embodiments, the reacting step comprises a reaction mixture of a lithium metal and/or a lithium salt, optionally lithium hydroxide, LiPF₆, LiTFSI, and/or LiBF₄; a sodium salt, optionally sodium hydroxide, NaTFSI, NaBF₄, and/or NaPF₆; an aluminum salt; a potassium salt; a magnesium salt; a calcium salt; a zinc salt; or any combination thereof, with at least two additional components selected from the group consisting of a deep eutectic solvent, choline chloride, levulinic acid, formic acid, lactic acid, glycerol, citric acid, sorbitol, xylitol, and ethylene glycol.

Various polyols can be employed in the methods of the presently disclosed subject matter. By way of example and not limitation, in some embodiments the polyol is selected from the group consisting of ethylene glycol, propanediol, butanediol, pentanediol, diethylene glycol, glycerol, and combinations thereof.

In some embodiments of the presently disclosed methods, the metal salts are present in the gel electrolyte at between 5-95 mol %.

In some embodiments of the presently disclosed methods, water produced in the reacting step is removed. Any method can be employed to remove the water side product, including but not limited to freeze-drying the products of the reaction.

Additional steps can be added to the presently described methods to modify the characteristics of the gel electrolyte as might be desired. By way of example and not limitation, in some embodiments the presently disclosed methods further comprise doping the gel electrolyte with a lithium salt, a sodium salt, a potassium salt, an aluminum salt, a zinc salt, a calcium salt, a magnesium salt, or any combination thereof. By way of further example and not limitation, in some embodiments the presently disclosed methods further comprise adding the gel electrolyte with electrolyte additives and/or organic solvents, consisting of vinylene carbonate, lithium carbonate, fluoroethylene carbonate, imidazole, gamma-valerolactone, n-methylpyrrolidone, and n-methylacetamide.

### EXAMPLES

The following EXAMPLES provide illustrative embodiments. In light of the present disclosure and the general level of skill in the art, those of skill will appreciate that the following EXAMPLES are intended to be exemplary only and that numerous changes, modifications, and alterations can be employed without departing from the scope of the presently disclosed subject matter.

### Materials and Methods for the Examples

Materials. All reagents were used as received. Their manufacturers, purity, and CAS numbers are shown in Table 6.

TABLE 6
Chemicals and Supplies Employed

| Description | CAS no. | Manufacturer/Supplier |
|---|---|---|
| Selenium powder (99+% purity) | 7782-49-2 | Acro Organics (Waltham, Massachusetts, |
| | | United States of America) |
| Activated carbon | 7440-44-0 | BeanTown Chemical (Hudson, New |
| | | Hampshire, United States of America) |
| PCN-250(Fe) | | Strem Chemicals, Inc (Newburyport, |
| | | Massachusetts, United States of |
| | | America) |
| Celgard 2400 (polypropylene) | | Celgard, LLC (Charlotte, North Carolina, |
| | | United States of America) |
| Poly(vinylidene fluoride-co- | 9011-17-0 | Sigma Aldrich (St. Louis, Missouri, |
| hexafluoropropylene (MW | | United States of America) |
| 455000 Da) | | |
| Carbon black (super P) (99+% | 1333-86-4 | Alfa Aesar (Tewksbury, Massachusetts, |
| purity) | | United States of America) |
| Lithium chip | | MTI Corp (Richmond, California, United |
| | | States of America) |
| Polytetrafluoroethylene (PTFE) | | MTI Corp (Richmond, California, United |
| Condensed Liquid Binder | | States of America) |
| Lithium bis(trifluoromethyl- | 90076-65-6 | VWR (Radnor, Pennsylvania, United |
| sulfonyl)imide (LiTFSI) | | States of America) |
| (>99% purity) | | |
| 1,2-dimethoxyethane (>99% | 110-71-4 | VWR (Radnor, Pennsylvania, United |
| purity) | | States of America) |
| 1,3-dioxolane (>99% purity) | 646-06-0 | VWR (Radnor, Pennsylvania, United |
| | | States of America) |

Synthesis of selenium encapsulated activated carbon (Se@AC). Selenium was loaded into the activated carbon by facial melt diffusion method to form Se@AC (Li et al., 2014). In short, dry activated carbon and selenium at 2:3 by weight was ball-milled at 300 rpm in acetone for 1 hour. After ball milling, the selenium and activated carbon mixture was dried at 80° C. for 6 hours to remove acetone. Dry selenium-activated carbon mixture was heated under N₂ at 10° C/min and held isothermally to 260° C. for 20 hours. Finally, the resulting sample was heated to 350° C. for 3 hours to remove physiosorbed selenium and cooled down to room temperature.

Fabrication of MOF separators. The PCN-250 MOF was dried at 150° C. under 70 cc/min N₂ flow over night prior to use to remove moisture. The PCN-250 separators were fabricated by a layering process. In short, ˜0.03 mg dry PCN-250 (0.1 wt. %) was dispersed in ethanol and sonicated for one hour to disperse PCN. The PCN solution (10 mL) was filtered through a conventional Celgard 2400 membrane. Then the pump was turned off to allow the PCN to distribute on the Celgard membrane. Then the 0.5 mL poly(vinylidene fluoride-co-hexafluoropropylene) (PVDF-HFP, MW 455000 Da) in acetone (5 wt. %) was filtered on top of the PCN layer to secure the PCN particles. The PCN and PVDF-HFP solutions was filtered alternately for three times to ensure the evenly distributed PCN-250 particles on the Celgard membrane. The resulting PCN separator was peeling off from the Celgard 2400 filter membrane. The obtained MOF separators were dried at 80° C. for 12 h in a vacuum oven prior to use.

Li—Se coin cells assembly. The cathode materials were prepared by making a slurry of Se@AC: water soluble binder (Teflon): carbon black (Super P) at 80:10:10 by weight. The mass loading of selenium was ˜1-1.5 mg/cm². The obtained slurry was coated onto the current collector and dried at 120° C. for 1 h in a vacuum oven to form the working electrode. Common 2032-type coin cells were assembled in an argon filled glove box with moisture and oxygen contents below 1 ppm. The electrolyte contained 1M LiTFSI in 1:1 (v/v) 1,2-dimethoxyethane (DME) and 1,3-dioxolane (DOL). The 1 wt. % LiNO₃ was used as an additive. The anode was prepared by directly pressing lithium metal foils onto 12 mm diameter stainless steel disc. The MOF separator were cut into 16 mm disc and placed in the cells. The conventional Celgard separator was used as a control.

Cyclic voltammetry. Cyclic voltammetry (CV) was performed by Autolab® using lithium metal foil as reference and counter electrodes and Se@AC as working electrode. The 10^{th} cycle was presented throughout to compare voltammogram after the stable cycle was achieved. Cyclic voltammogram of the Se AC were conducted between 0.5-3.0 V at a scan rate of 0.1 mV/s.

Li-ion transference number (t_{Li+}). A CR2032 type coin cell using two lithium metal electrodes (Li/electrolyte/Li) was assembled in an argon-filled glovebox and used for measurement. The cells were left under open circuit voltage (OCV) for at least 12 h prior to measurement. The combination of EIS and direct current DC polarization measurements, as described by Bruce and Vincent (Bruce & Vincent, 1987), was used to measure t_{Li+}.

Electrochemical performance. To determine the cycling stability of the cells, galvanostatic charge/discharge tests were performed at 0.2 C for 100 cycles using an Arbin battery testing unit (College Station, Tex., USA) at various current densities at a cut-off voltage of 1.0-3.0 V versus Li/Li⁺. The current density was calculated based on the weight of selenium (1 C=˜675 mAh/g). Electrochemical impedance spectroscopy (EIS) was measured in the frequency ranging from 100 kHz to 10 mHz with a voltage amplitude of 5 mV. Before cyclic voltammetry, cycling stability, and C-rate, the cells were treated with 10 cycles of galvanostatic charge/discharge at a low rate of 0.2 C for activation.

### EXAMPLE 1

### Production of MOF Separators

FIG. 10 shows the resulting flexible MOF separator. To examine the physiochemical properties of the MOF, we characterized PCN-250 by FTIR, XRD, and N₂-adsorption/desorption. PCN-250 had a high surface area of 1251 m²/g and pore volume of 0.56 cc/g (0.51 cc/g micro-pore volume), consistent with the previously reported values (Fang et al., 2018; Wang et al., 2018). The HRTEM images revealed that PCN-250 is porous and the Fe is well dispersed.

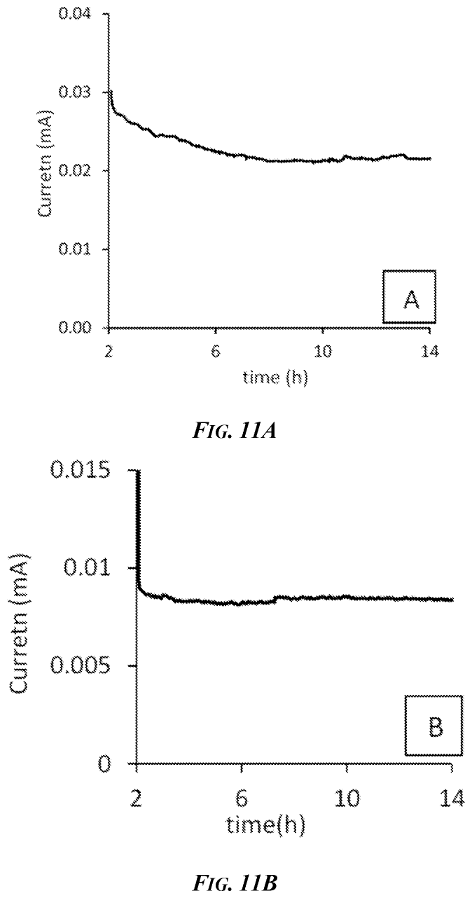

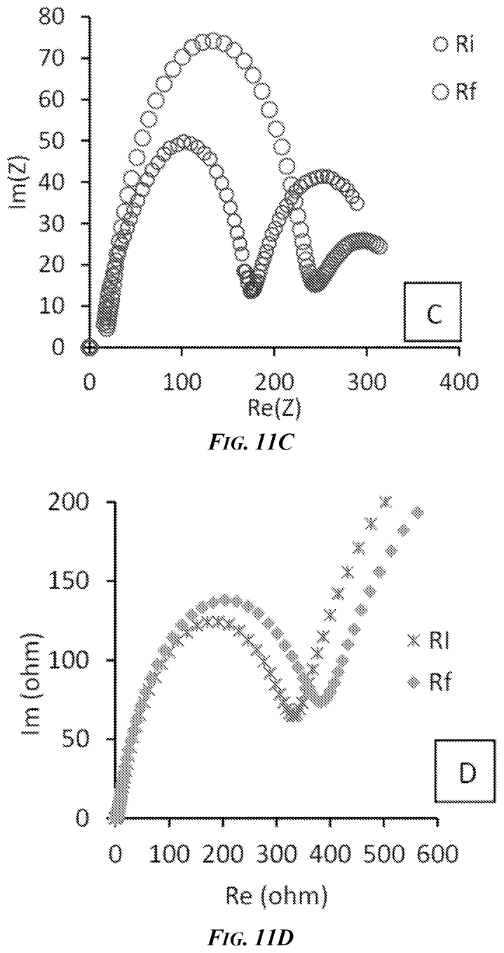

To assess the ability of MOF separator to suppress the mobility of anions and lithium polyselenides, we performed Li⁺ transference number measurements to elucidate the relative ionic diffusivity in the electrolyte. The Li⁺ transference number of conventional cells using the Celgard separator is usually ˜0.20 to 0.45 (Evans et al., 1987; Zhao et al., 2008; Li et al., 2019). Here, the Li⁺ transference number of cells using MOF separator was 0.7 (FIG. 11A), much higher than that of Celgard separator (FIG. 11B). The significant increase in Li⁺ transference number using MOF separator suggested Lewis acidic PCN can effectively immobilize anions (Lewis base) of the salt and permit Li⁺ to transport.

### EXAMPLE 2

### Electrochemical Impedance Determinations

To evaluate the formation of the solid electrolyte interface and resistivity of the cell, electrochemical impedance spectroscopy was conducted after Li⁺ transference number measurements (FIGS. 11C and 11D). The cells using MOF and Celgard separators demonstrated an increase in resistance, suggesting the formation of stable solid electrolyte interface. In case of Celgard, the cell resistance increased more than that of MOF separator, indicating that a thick SEI layer formed using Celgard compared to MOF separator.

### EXAMPLE 2

### Open-Circuit Voltage (OCV) Determinations

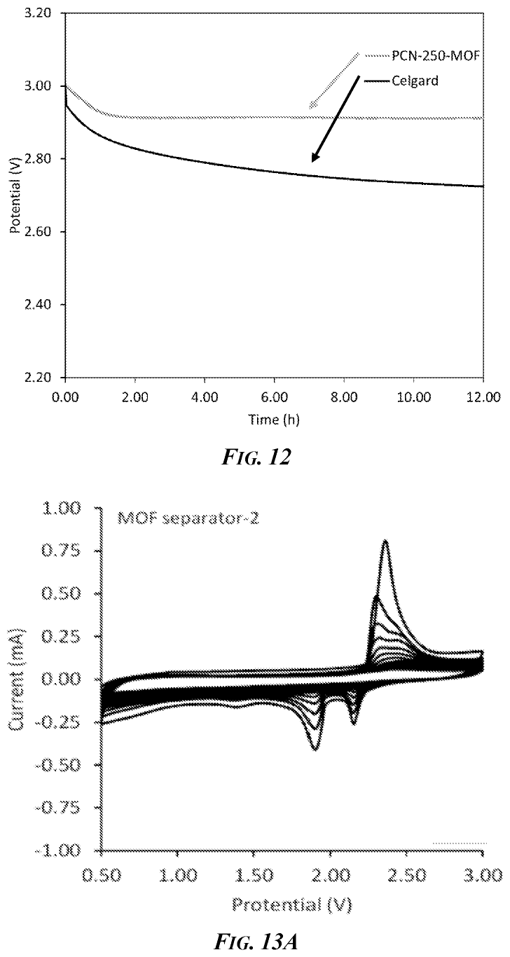

To understand the effect of self-discharge inhibition, we performed normalized open-circuit voltage (OCV) using PCN and Celgard separators over 12 hours (FIG. 12). As a control, the OCV profile of the cell using Celgard separator progressively declined (FIG. 12). In a contrast, the cell with PCN separator demonstrated the OCV of 2.9 after 48 hours. The retention of the OCV suggested that the PCN separator effectively suppressed the lithium polyselenide shuttling owing to the strong interactions between Lewis acidic Fe(II) center and the polyselenide base.

### EXAMPLE 3

### Redox Behavior Determinations

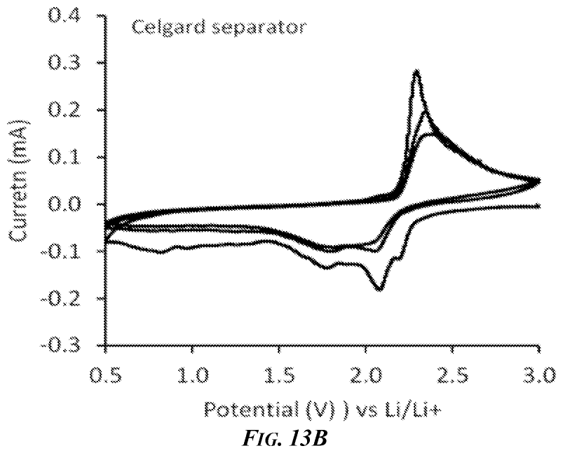

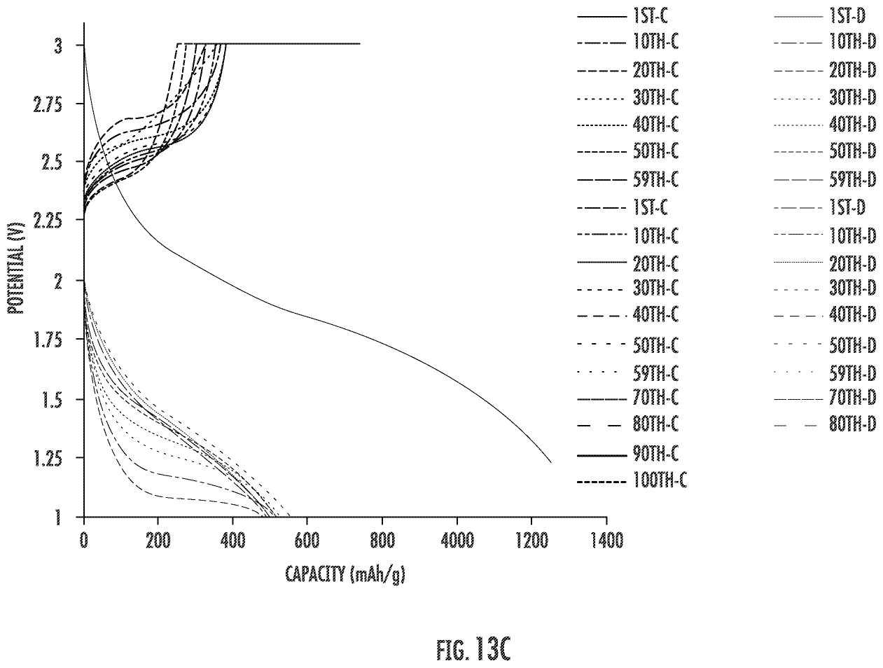

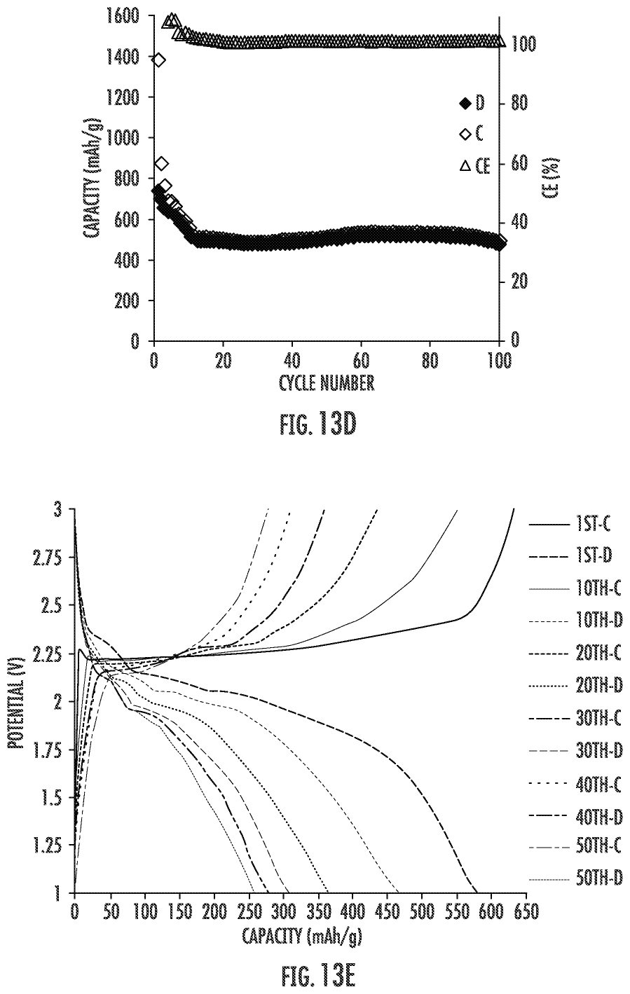

To investigate the redox behavior of lithium polyselenides in the electrolyte, we performed cyclic voltammetry using MOF separator. The control experiment using Celgard-2400 showed one oxidation peak at 2.3 V and a fuzzy reaction region (FIG. 13A). These results suggested that the formed lithium poly-selenides diffused to the anode and formed inactive insoluble lithium selenides. The MOF separator showed one oxidation peak at 2.3V and two pronounced reduction peaks at 1.9 and 2.2 V (FIG. 13B), corresponding to the conversion of soluble lithium polyselenides (Li₂Seₓ, 4≤x≤8) and insoluble lithium polyselenides (Li₂Se₂ and Li₂Se).

Initial activation cycles are necessary in lithium-selenium batteries because of a large interfacial contact area between carbon carrier and selenium. Our results demonstrated initial activation cycles that leads to a reversible and stable electrochemical performance. The cell with a PCN separator was measured at C/5 over 200 cycles (FIG. 13C). The initial discharge capacity was 1073 mAh/g, followed by a drop to ˜500 mAh/g at 12^{th} cycle. This capacity remained relatively constant with a high coulombic efficiency, exhibiting a high capacity retention (FIG. 13D). These results are consistent with the CV measurement.

The capacity of the cell using Celgard separator progressively decreased to 260 mAh/g after 50^{th} cycle (FIG. 13E). In contrast, the cell with MOF separator demonstrated the initial capacity drop is because of the activation of the cell. Thereafter the cycling performance was stable and retained the capacity of ˜500 mAh/g after 100 cycles. These results suggested a better efficiency and kinetics of the cell using PCN separator compared to that of Celgard.

Coulombic efficiency is the key indicator for long-term cycling capability. The coulombic efficiency of cell using MOF separator remained relatively constant at >97% over 100 cycles at 0.2 C.

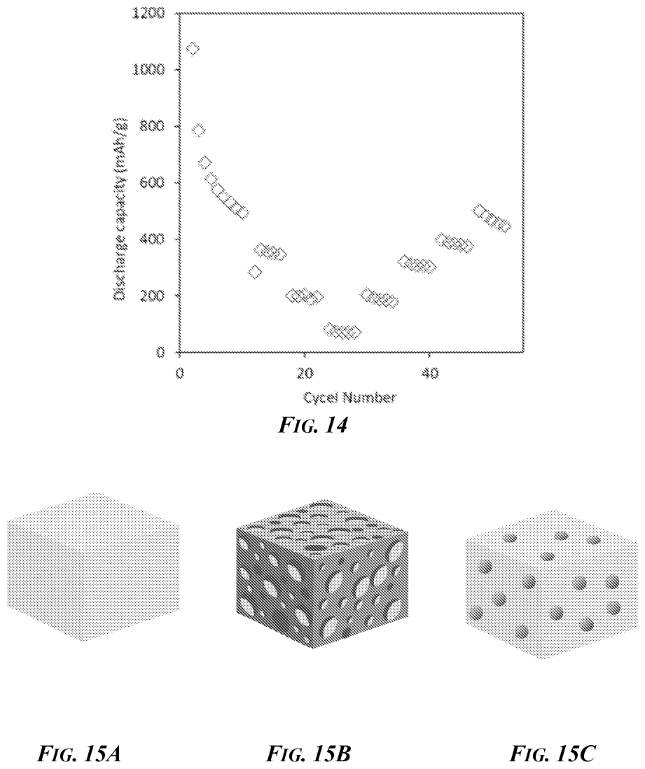

To better understand the redox behavior of the cell at different charge/discharge rates, we measured the electrochemical performance at different C-rates using MOF separators. As a control, the cell with conventional Celgard separator suffered from dramatic capacity decay. Whereas the cell with PCN separator demonstrated a much better performance (FIG. 14). After an initial discharge capacity of 1073 mAh/g at C/5, the capacity reached 495 mAh/g. When cycling at different C-rates, the capacities remained relatively constant at ˜490 mAh/g for C/5, 350 mAh/g for C/2, 195 mAh/g for 2 C. Then the capacity returned to 450 mAh/g at C/5. Coulombic efficiency is the key indicator for long-term cycling capability. The coulombic efficiency of cell using PCN-250 separator remained relatively constant at >97% over 200 cycles at 0.2 and 1 C.

### Discussion of the Examples

In summary, the MOF separator was fabricated to improve the performance of Li—Se batteries. The Li—Se battery cell using the MOF separator and selenium encapsulated activated carbon as the cathode demonstrated high cycle stability with a discharge capacity of 500 mAh/g at a current density of 0.2 C. The ionic sieving capacity of MOF separator is promising for rechargeable batteries because (1) the pore size of MOFs can be tuned for different lithium-based battery systems (Li—S, Na—S, Li-ion, Li—Se, Li—Te, Na—Se), and (2) the proposed fabrication technique of the MOF separator is unique and simple, compared to self-assembly counterpart. The simplicity of this fabrication technique can be used to create separator using other MOF structures. The use of MOF-based separator to prevent side reaction of soluble organic redox intermediates will lead to the development of rechargeable organic batteries with high energy density and long cycling life.

### REFERENCES

All references cited in the instant disclosure, including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
Bruce & Vincent (1987) J Electroanal Chem Interfacial Electrochem 225(1):1-17.
Evans et al. (1987) Polymer 28(13):2324-2328.
Fang et al. (2018) Chem Engineering J 337:532-540.
Li et al. (2014) Nano Energy 9:229-236.
Li et al. (2019) Advanced Energy Materials 9(10):1803422.
Liu et al. (2016) Appl Petrochem Res 6(3):209-215.
Schoedel & Rajeh (2020) Top Curr Chem 378:1-55.
U.S. Patent Application Publication No. 2020/0295333.
U.S. Pat. Nos. 6,692,640; 7,550,641; 8,932,974; 9,163,036; 9,688,541; 9,777,029; 10,195,592; 10,347,939; and 10,427,143.
Wang et al. (2018) J Colloid Interface Sci 519:273-284.
Wu et al. (2019) Nanomaterials 9(9):1192.
Zhao et al. (2008) Determination of lithium-ion transference numbers in LiPF6-PC solutions based on electrochemical polarization and NMR measurements. J Electrochem Soc 155(4):A292.

It will be understood that various details of the presently disclosed subject matter can be changed without departing from the scope of the presently disclosed subject matter. Furthermore, the foregoing description is for the purpose of illustration only, and not for the purpose of limitation.

1. A gel electrolyte comprising:
(a) a glycolate gel, a glycerate gel, a methylsulfonylmethane gel, or any combination thereof;
(b) one or more metal salts, wherein the one or more metal salts are selected from the group consisting of alkali salts, alkaline-earth salts, and transition salts;
(c) one or more anions (such as LiTFSI, LiFSI, LiPF6, LiClO4, NaTFSI, NaFSI, and NaPF6); and
(d) a biomass-derived compound and/or a polyol.

2. The gel electrolyte of claim 1, wherein:
(i) the alkali salts are selected from the group consisting of salts of lithium, sodium, and potassium; and/or
(ii) the alkaline-earth salts are selected from the group consisting of salts of magnesium, beryllium, and calcium; and/or
(iii) the transition salt is an aluminum salt.

3. The gel electrolyte of claim 1, where in the concentration of the one or more salts in the gel electrolyte is at least about 10 mol percent.

4. The gel electrolyte of claim 1, wherein the gel electrolyte is in the form of a homogeneous eutectic mixture.

5. A solid electrolyte comprising one or more porous solid materials, wherein the one or more porous solid materials are optionally selected from the group consisting of a metal-organic framework (MOF), a zeolite, a silica-alumina, a mesoporous silica, activated carbon, asphalt, coal, a biomass-derived porous material, and a plastic material.

6. The solid electrolyte of claim 5, wherein:
(i) the metal-organic framework (MOF) is selected from the group consisting of UiO-66(Zr, Ce, Hf) MOF, a MIL-101(Al, Cr, Fe) MOF, a MIL-125(Ti) MOF, and a MIL-53(Al, Fe) MOF; and/or
(ii) the zeolite is selected from the group consisting of ZSM-5, HY, BETA, SAPO, and MOR; and/or
(iii), the mesoporous silica is SBA-15; and/or
(iv) the plastic material is selected from the group consisting of polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene.

7. A composite electrolyte comprising the gel electrolyte of claim 1 and a solid electrolyte comprising one or more porous solid materials, wherein the one or more porous solid materials are optionally selected from the group consisting of a metal-organic framework (MOF), a zeolite, a silica-alumina, a mesoporous silica, activated carbon, asphalt, coal, a biomass-derived porous material, and a plastic material.

8. The composite electrolyte of claim 7 for use in an electrochemical system.

9. The composite electrolyte of claim 8, wherein the electrochemical system is selected from the group consisting of a rechargeable battery, a supercapacitor, a flow battery, an electrochromic device, and a fuel cell.

10. The composite electrolyte of claim 7, wherein the gel electrolyte is produced from a plant biomass and the solid electrolyte comprises a plastic material, optionally a plastic material selected from the group consisting of polypropylene, polyethylene, polycarbonate, polyethylene terephthalate, polyvinylchloride, polylactate, polycaprolactone, polyhydroxyalkanoates, polybutylene succinate, polyethylene succinate, polyethylene adipate, polybutylene adipate terephthalate, polybutylene succinate terephthalate, polyvinyl alcohol, and polystyrene, a combination thereof, or a compound derived therefrom, wherein the compound derived therefrom is optionally an organic acid selected from the group consisting of on oxalic acid, malic acid, malonic acid, succinic acid, acetic acid, and formic acid.

11. The composite electrolyte of claim 10, wherein the plant biomass is generated from an agricultural product, optionally an agricultural product selected from the group consisting of corn stover, rice straw, wheat straw, and soybean straw; a hardwood, optionally a hardwood selected from the group consisting of poplar and eucalyptus; a softwood, optionally a softwood selected from the group consisting of pine, spruce, and douglas fir.

12. The composite electrolyte of claim 7, wherein the gel electrolyte has an ionic conductivity of at least about 10⁻⁴ S/cm.

13. The composite electrolyte of claim 7, wherein the gel electrolyte, the composite electrolyte, or both are nonflammable.

14. The composite electrolyte of claim 7, wherein the composite electrolyte has a thermal stability of greater than 100° C.

15. The composite electrolyte of claim 7, wherein electrochemical cells with the composite electrolyte can operate at a temperature of below 4° C.

16. The composite electrolyte of claim 7, wherein the gel electrolyte is encapsulated in a porous solid material, optionally wherein the porous solid materials is selected from the group consisting of a metal-organic framework (MOF), a zeolite, a silica-alumina, a biomass-derived porous material, or any combination thereof.

17. The composite electrolyte of claim 7, wherein the porous solid material is present within the gel electrolyte.

18. An electrochemical device comprising the composite electrolyte of claim 7.

19. The electrochemical device of claim 18, wherein the electrochemical device is a lithium-ion battery, a lithium-metal battery, an electrochromic device, an electrodeposition system, a fuel cell, a redox flow battery, or any combination thereof.

20. A method for producing a gel electrolyte using the exchange in hydrogen bonds (reaction between hydrogen bond donors and hydrogen bond acceptors), the method comprising reacting a polyol or other biomass-derived compound with a metal selected from the group consisting of lithium, sodium, aluminum, potassium, magnesium, calcium, and zinc, a salt thereof, and water or any combination thereof.

21. The method of claim 20, wherein:
(i) the lithium salt is selected from the group consisting of lithium hydroxide, LiPF₆, LiTFSI, and LiBF₄; and/or
(ii) the sodium salt is selected from the group consisting of sodium hydroxide (NaOH), NaTFSI, NaBF₄ and NaPF₆.

22. The method of claim 20, wherein the reacting comprises reacting the polyol with a lithium salt, optionally lithium hydroxide, at 25-60° C. for at least 1 hour.

23. The method of claim 22, wherein the lithium salt is present in the reaction in a concentration of about 0.1 to about 5.0 M.

24. The method of claim 20, wherein the polyol is selected from the group consisting of ethylene glycol, propanediol, butanediol, pentanediol, diethylene glycol, glycerol, and combinations thereof.

25. The method of claim 20, wherein the metal salts are present in the gel electrolyte between 5-95 mol %.

26. The method of claim 20, wherein water produced in the reacting step is removed, optionally by freeze-drying the products of the reaction.

27. The method of claim 20, further comprising doping the gel electrolyte with a lithium salt, a sodium salt, a potassium salt, an aluminum salt, a zinc salt, a calcium salt, a magnesium salt, or any combination thereof.

28. The method of claim 20, further comprising adding the gel electrolyte with electrolyte additives and/or organic solvents, consisting of vinylene carbonate, lithium carbonate, fluoroethylene carbonate, imidazole, gamma-valerolactone, n-methylpyrrolidone, and n-methylacetamide.

29. The method of claim 20, wherein the reacting step comprises a reaction mixture of a lithium metal and/or a lithium salt, optionally lithium hydroxide, LiPF₆, LiTFSI, and/or LiBF₄; a sodium salt, optionally sodium hydroxide, NaTFSI, NaBF₄, and/or NaPF₆; an aluminum salt; a potassium salt; a magnesium salt; a calcium salt; a zinc salt; or any combination thereof, with at least two additional components selected from the group consisting of a deep eutectic solvent, choline chloride, levulinic acid, formic acid, lactic acid, glycerol, citric acid, sorbitol, xylitol, and ethylene glycol.

30. The solid electrolyte of claim 5 for use in an electrode.

31. The solid electrolyte of claim 5 for use as a host for electrode materials, optionally S, Se, Te, Si, and/or SiO₂ in electrochemical and energy storage devices, further optionally wherein the electrochemical and energy storage devices are selected from the group consisting of batteries, capacitors, and fuel cells.

32. The solid electrolyte of claim 5 for use as a template for forming a carbon templated electrode material.

33. A separator for use in an electrochemical cell, the separator comprising the solid electrolyte of claim 5.
